(19) United States
(12) Patent Application Publication
(10) Pub. No.: US 2018/0129026 A1
(43) Pub. Date: May 10, 2018

(54) VARIABLE POWER OPTICAL SYSTEM, OPTICAL APPARATUS, AND VARIABLE POWER OPTICAL SYSTEM MANUFACTURING METHOD

(71) Applicant: Nikon Corporation, Minato-ku, Tokyo (JP)

(72) Inventors: Hiroshi YAMAMOTO, Kawasaki-shi (JP); Taku MATSUO, Kawasaki-shi (JP); Akihiko OBAMA, Tokyo (JP); Kensuke UCHIDA, Fujisawa-shi (JP)

(21) Appl. No.: 15/539,017

(22) PCT Filed: Dec. 25, 2015
(86) PCT No.: PCT/JP2015/086407

§ 371 Date: Nov. 18, 2017

(30) Foreign Application Priority Data
Dec. 26, 2014 (JP) 2014-266036

(51) Int. Cl. G02B 15/20; G02B 27/64; G02B 15/163

(52) U.S. Cl. CPC G02B 15/20; G02B 15/163; G02B 27/646

(57) ABSTRACT

A variable magnification optical system includes: a first lens group having a positive refractive power and arranged closest to an object; a negative lens group having a negative refractive power and arranged closer to an image than the first lens group; and a focusing group arranged between the negative lens group and an aperture stop, wherein when varying magnification, the distance between the first lens group and the negative lens group is changed, and the distance between the negative lens group and the aperture stop is changed, wherein when focusing, the distance between the focusing group and a lens arranged at a position to face an object-side of the focusing group is changed, and the distance between the focusing group and a lens arranged at a position to face an image-side of the focusing group is changed, wherein the focusing group is constituted by one single lens having a positive refractive power, and a predetermined conditional expression is satisfied.

### TECHNICAL FIELD

The present invention relates to a variable magnification optical system, an optical apparatus, and a variable magnification optical system manufacturing method. Priority is claimed on Japanese Patent Application No. 2014-266036, filed on Dec. 26, 2014, the contents of which are incorporated herein by reference.

### TECHNICAL BACKGROUND

In the related art, variable magnification optical systems which are suitable for photographic cameras, electronic still cameras, video cameras, and the like have been proposed (for example, refer to Patent Document 1).

### RELATED ART DOCUMENTS

### Patent Document

Patent Document 1: Japanese Patent Application, Publication No. 2010-217838

### SUMMARY OF INVENTION

### Technical Problem

However, there is a problem in that the variable magnification optical systems in the related art as described above cannot achieve a satisfactory optical performance.

### Solution to Problem

A variable magnification optical system according to an aspect of the present invention includes: a first lens group having a positive refractive power and arranged closest to an object; a negative lens group having a negative refractive power and arranged closer to an image than the first lens group; and a focusing group arranged between the negative lens group and an aperture stop, wherein when varying magnification, a distance between the first lens group and the negative lens group is changed, and a distance between the negative lens group and the aperture stop is changed, wherein when focusing, a distance between the focusing group and a lens arranged at a position to face an object-side of the focusing group is changed, and a distance between the focusing group and a lens arranged at a position to face an image-side of the focusing group is changed, wherein the focusing group is constituted by one single lens having a positive refractive power, and wherein the following conditional expression is satisfied:

1.40<f1/ff<2.20

where

f1: a focal length of the first lens group, and

ff: a focal length of the focusing group.

A variable magnification optical system according to another aspect of the present invention includes: a first lens group having a positive refractive power and arranged closest to an object; a negative lens group having a negative refractive power and arranged closer to an image than the first lens group; a positive lens group having a vibration-reduction group movable such that at least part of the vibration-reduction group has a component in a direction orthogonal to an optical axis; and a focusing group arranged between the negative lens group and the positive lens group, wherein when varying magnification, a distance between the first lens group and the negative lens group is changed, and a distance between the negative lens group and the positive lens group is changed, wherein when focusing, a distance between the focusing group and a lens arranged at a position to face an object-side of the focusing group is changed, and a distance between the focusing group and a lens arranged at a position to face an image-side of the focusing group is changed, wherein the focusing group is constituted by one single lens having a positive refractive power, and wherein the following conditional expression is satisfied:

1.40<f1/ff<2.20

where

f1: a focal length of the first lens group, and

ff: a focal length of the focusing group.

Another aspect of the present invention provides a variable magnification optical system, including: in order from an object, a first lens group having a positive refractive power; a second lens group having a negative refractive power; a third lens group having a positive refractive power; and a fourth lens group having a positive refractive power, wherein when varying magnification, a distance between the first lens group and the second lens group is changed, a distance between the second lens group and the third lens group is changed, and a distance between the third lens group and the fourth lens group is changed, wherein the third lens group is constituted by one single lens having a positive refractive power, and wherein the following conditional expression is satisfied:

1.40<f1/ff<2.20

where

f1: a focal length of the first lens group, and

ff: a focal length of the third lens group.

Another aspect of the present invention provides an optical apparatus that includes the variable magnification optical system.

A variable magnification optical system manufacturing method according to another aspect of the present invention is a manufacturing method of a variable magnification optical system, including: a first lens group having a positive refractive power and arranged closest to an object; a negative lens group having a negative refractive power and arranged closer to an image than the first lens group; and a focusing group arranged between the negative lens group and an aperture stop, the method including: arranging, when varying magnification, such that a distance between the first lens group and the negative lens group is changed, and a distance between the negative lens group and the aperture stop is changed; arranging, when focusing, such that a distance between the focusing group and a lens arranged at a position to face an object-side of the focusing group is changed, and a distance between the focusing group and a lens arranged at a position to face an image-side of the focusing group is changed; and configuring such that the focusing group is constituted by one single lens having a positive refractive power, wherein the following conditional expression is satisfied:

1.40<f1/ff<2.20

where

f1: a focal length of the first lens group, and

ff: a focal length of the focusing group.

Another aspect of the present invention provides a variable magnification optical system manufacturing method that is a manufacturing method of a variable magnification optical system, including: in order from an object, a first lens group having a positive refractive power; a second lens group having a negative refractive power; a third lens group having a positive refractive power; and a fourth lens group having a positive refractive power, the method including: causing the third lens group to be constituted by one single lens having a positive refractive power; causing the variable magnification optical system to satisfy the following conditional expression; and when varying magnification, changing a distance between the first lens group and the second lens group, changing a distance between the second lens group and the third lens group, and changing a distance between the third lens group and the fourth lens group:

1.40<f1/ff<2.20

where

f1: a focal length of the first lens group, and

ff: a focal length of the third lens group.

### BRIEF DESCRIPTION OF THE DRAWINGS

FIG. 1 is a cross-sectional view showing a lens configuration of a variable magnification optical system according to Example 1.

FIG. 2 shows graphs of various aberrations of the variable magnification optical system according to Example 1 when focusing an object at infinity. Part (a) of FIG. 2 shows various aberrations in a wide-angle end state. Part (b) of FIG. 2 shows various aberrations in an intermediate focal length state. Part (c) of FIG. 2 shows various aberrations in a telephoto end state.

FIG. 3 shows graphs of various aberrations of the variable magnification optical system according to Example 1 when focusing an object at a close distance. Part (a) of FIG. 3 shows various aberrations in the wide-angle end state. Part (b) of FIG. 3 shows various aberrations in the intermediate focal length state. Part (c) of FIG. 3 shows various aberrations in the telephoto end state.

FIG. 4 is a cross-sectional view showing a lens configuration of a variable magnification optical system according to Example 2.

FIG. 5 shows graphs of various aberrations of the variable magnification optical system according to Example 2 when focusing an object at infinity. Part (a) of FIG. 5 shows various aberrations in the wide-angle end state. Part (b) of FIG. 5 shows various aberrations in the intermediate focal length state. Part (c) of FIG. 5 shows various aberrations in the telephoto end state.

FIG. 6 shows graphs of various aberrations of the variable magnification optical system according to Example 2 when focusing an object at a close distance. Part (a) of FIG. 6 shows various aberrations in the wide-angle end state. Part (b) of FIG. 6 shows various aberrations in the intermediate focal length state. Part (c) of FIG. 6 shows various aberrations in the telephoto end state.

FIG. 7 is a cross-sectional view showing a lens configuration of a variable magnification optical system according to Example 3.

FIG. 8 shows graphs of various aberrations of the variable magnification optical system according to Example 3 when focusing an object at infinity. Part (a) of FIG. 8 shows various aberrations in the wide-angle end state. Part (b) of FIG. 8 shows various aberrations in the intermediate focal length state. Part (c) of FIG. 8 shows various aberrations in the telephoto end state.

FIG. 9 shows graphs of various aberrations of the variable magnification optical system according to Example 3 when focusing an object at a close distance. Part (a) of FIG. 9 shows various aberrations in the wide-angle end state. Part (b) of FIG. 9 shows various aberrations in the intermediate focal length state. Part (c) of FIG. 9 shows various aberrations in the telephoto end state.

FIG. 10 is a cross-sectional view showing a lens configuration of a variable magnification optical system according to Example 4.

FIG. 11 shows graphs of various aberrations of the variable magnification optical system according to Example 4 when focusing an object at infinity. Part (a) of FIG. 11 shows various aberrations in the wide-angle end state. Part (b) of FIG. 11 shows various aberrations in the intermediate focal length state. Part (c) of FIG. 11 shows various aberrations in the telephoto end state.

FIG. 12 shows graphs of various aberrations of the variable magnification optical system according to Example 4 when focusing an object at a close distance. Part (a) of FIG. 12 shows various aberrations in the wide-angle end state. Part (b) of FIG. 12 shows various aberrations in the intermediate focal length state. Part (c) of FIG. 12 shows various aberrations in the telephoto end state.

FIG. 13 is a diagram showing a configuration of an example of a camera that includes a variable magnification optical system.

FIG. 14 is a view showing an outline of an example of a variable magnification optical system manufacturing method.

FIG. 15 is a view showing an outline of an example of a variable magnification optical system manufacturing method.

### DESCRIPTION OF EMBODIMENTS

Hereinafter, a variable magnification optical system, an optical apparatus, and a variable magnification optical system manufacturing method are described.

In an embodiment, a variable magnification optical system includes: a first lens group having a positive refractive power and arranged closest to an object; a negative lens group having a negative refractive power and arranged closer to an image than the first lens group; and a focusing group arranged between the negative lens group and an aperture stop, wherein when varying magnification, the distance between the first lens group and the negative lens group is changed, and the distance between the negative lens group and the aperture stop is changed. According to the configuration, while realizing varying magnification from a wide-angle end state to a telephoto end state, it is possible to realize a satisfactory optical performance even when varying magnification. Further, when focusing, the distance between the focusing group and a lens arranged at a position to face an object-side of the focusing group is changed, and the distance between the focusing group and a lens arranged at a position to face an image-side of the focusing group is changed, and the focusing group is constituted by one single lens having a positive refractive power. According to the configuration, while downsizing a lens barrel, it is possible to satisfactorily correct aberration variation when varying magnification.

In an alternative embodiment, a variable magnification optical system includes: a first lens group having a positive refractive power and arranged closest to an object; a negative lens group having a negative refractive power and arranged closer to an image than the first lens group; a positive lens group having a vibration-reduction group movable such that at least part of the vibration-reduction group has a component in a direction orthogonal to an optical axis; and a focusing group arranged between the negative lens group and the positive lens group, wherein when varying magnification, the distance between the first lens group and the negative lens group is changed, and the distance between the negative lens group and the positive lens group is changed. According to the configuration, while realizing varying magnification from a wide-angle end state to a telephoto end state, it is possible to realize a satisfactory optical performance even when varying magnification. Further, when focusing, the distance between the focusing group and a lens arranged at a position to face an object-side of the focusing group is changed, and the distance between the focusing group and a lens arranged at a position to face an image-side of the focusing group is changed, and the focusing group is constituted by one single lens having a positive refractive power. According to the configuration, while downsizing a lens barrel, it is possible to satisfactorily correct aberration variation when varying magnification.

In another alternative embodiment, a variable magnification optical system includes: in order from an object, a first lens group having a positive refractive power; a second lens group having a negative refractive power; a third lens group having a positive refractive power; and a fourth lens group having a positive refractive power, wherein when varying magnification, the distance between the first lens group and the second lens group is changed, the distance between the second lens group and the third lens group is changed, and the distance between the third lens group and the fourth lens group is changed. According to the configuration, while realizing varying magnification from a wide-angle end state to a telephoto end state, it is possible to realize a satisfactory optical performance even when varying magnification. Further, the third lens group is constituted by one single lens having a positive refractive power. According to the configuration, while downsizing a lens barrel, it is possible to satisfactorily correct aberration variation when varying magnification.

In the embodiments, the variable magnification optical system can preferably satisfy Conditional Expression (1) below.

1.40<f1/ff<2.20 (1)

where

f1: a focal length of the first lens group, and

ff: a focal length of the focusing group (third lens group).

Conditional Expression (1) is a conditional expression for defining a ratio of the focal length of the first lens group to the focal length of the focusing group (focusing lens group, third lens group). When Conditional Expression (1) is satisfied, the variable magnification optical system can satisfactorily correct spherical aberration, on-axis chromatic aberration, and coma aberration in the telephoto end state.

In the variable magnification optical system, when the correspondence value of Conditional Expression (1) is smaller than the lower limit value, the refractive power of the first lens group becomes large. Thereby, it becomes difficult to correct spherical aberration and on-axis chromatic aberration in the telephoto end state, and therefore, this is not preferable. In order to reliably obtain the effect, the lower limit value of Conditional Expression (1) can be preferably 1.45. In order to further reliably obtain the effect, the lower limit value of Conditional Expression (1) can be preferably 1.48.

On the other hand, in the variable magnification optical system, when the correspondence value of Conditional Expression (1) exceeds the upper limit value, the refractive power of the third lens group becomes large. Thereby, it becomes difficult to correct spherical aberration and coma aberration in the telephoto end state, and therefore, this is not preferable. In order to reliably obtain the effect, the upper limit value of Conditional Expression (1) can be preferably 2.00. In order to further reliably obtain the effect, the upper limit value of Conditional Expression (1) can be preferably 1.93.

According to the above configuration, it is possible to realize a variable magnification optical system having a satisfactory optical performance. In the variable magnification optical system of the related art as described above, aberration variation when focusing an object at a close distance is large. Further, the variable magnification optical system of the related art has a configuration in which a heavy first lens group is extended when focusing an object at a close distance, and therefore, a burden imposed on an autofocus mechanism such as a motor is large. On the other hand, in the embodiment described above, the variable magnification optical system can prevent aberration variation when focusing an object at a close distance. Further, in the embodiments, the variable magnification optical system employs an inner focus method and has a configuration in which focusing is performed using a compact lightweight lens, and therefore, a burden imposed on the autofocus mechanism is small.

In the embodiments, the variable magnification optical system can preferably perform focusing from an object at infinity to an object at a close distance by moving the focusing group (third lens group) along an optical axis. According to the configuration, it is possible to satisfactorily correct aberration variation when focusing.

In the embodiments, it can be preferable that the variable magnification optical system include: in order from an object, a first lens group having a positive refractive power; and a second lens group (negative lens group) having a negative refractive power, wherein when varying magnification, the distance between the first lens group and the second lens group is changed, and wherein Conditional Expression (2) below is satisfied.

2.00<f1/(−f2)<4.00 (2)

where

f1: a focal length of the first lens group, and

f2: a focal length of the second lens group.

Conditional Expression (2) is a conditional expression for defining a ratio of the focal length of the first lens group to the focal length of the second lens group. When Conditional Expression (2) is satisfied, the variable magnification optical system can satisfactorily correct spherical aberration and on-axis chromatic aberration in the telephoto end state and coma aberration and astigmatism in the wide-angle end state.

In the variable magnification optical system, when the correspondence value of Conditional Expression (2) is smaller than the lower limit value, the refractive power of the first lens group becomes large. Thereby, it becomes difficult to correct spherical aberration and on-axis chromatic aberration in the telephoto end state, and therefore, this is not preferable. In order to reliably obtain the effect, the lower limit value of Conditional Expression (2) can be preferably 2.50. In order to further reliably obtain the effect, the lower limit value of Conditional Expression (2) can be preferably 2.85.

On the other hand, in the variable magnification optical system, when the correspondence value of Conditional Expression (2) exceeds the upper limit value, the refractive power of the second lens group becomes large. Thereby, it becomes difficult to correct coma aberration and astigmatism in the wide-angle end state, and therefore, this is not preferable. In order to reliably obtain the effect, the upper limit value of Conditional Expression (2) can be preferably 3.70. In order to further reliably obtain the effect, the upper limit value of Conditional Expression (2) can be preferably 3.63.

In the embodiments, it can be preferable that the variable magnification optical system include: in order from an object, a first lens group having a positive refractive power; a second lens group (negative lens group) having a negative refractive power; and a third lens group having a positive refractive power, wherein when varying magnification, the distance between the first lens group and the second lens group is changed, and the distance between the second lens group and the third lens group is changed, and wherein Conditional Expression (3) below is satisfied.

1.00<ff/(−f2)<2.30 (3)

where

f2: a focal length of the second lens group, and

ff: a focal length of the third lens group.

Conditional Expression (3) is a conditional expression for defining a ratio of the focal length of the third lens group to the focal length of the second lens group. In the variable magnification optical system, when Conditional Expression (3) is satisfied, it is possible to satisfactorily correct spherical aberration and coma aberration in the telephoto end state and coma aberration and astigmatism in the wide-angle end state.

In the variable magnification optical system, when the correspondence value of Conditional Expression (3) is smaller than the lower limit value, the refractive power of the third lens group becomes large. Thereby, it becomes difficult to correct spherical aberration and coma aberration in the telephoto end state, and therefore, this is not preferable. In order to reliably obtain the effect, the lower limit value of Conditional Expression (3) can be preferably 1.40. In order to further reliably obtain the effect, the lower limit value of Conditional Expression (3) can be preferably 1.61.

On the other hand, in the variable magnification optical system, when the correspondence value of Conditional Expression (3) exceeds the upper limit value, the refractive power of the second lens group becomes large. Thereby, it becomes difficult to correct coma aberration and astigmatism in the wide-angle end state, and therefore, this is not preferable. In order to reliably obtain the effect, the upper limit value of Conditional Expression (3) can be preferably 2.20. In order to further reliably obtain the effect, the upper limit value of Conditional Expression (3) can be preferably 2.16.

In the embodiments, it can be preferable that the variable magnification optical system include: in order from an object, a first lens group having a positive refractive power; a second lens group (negative lens group) having a negative refractive power; a third lens group having a positive refractive power; and a fourth lens group (positive lens group) having a positive refractive power, wherein when varying magnification, the distance between the first lens group and the second lens group is changed, the distance between the second lens group and the third lens group is changed, and the distance between the third lens group and the fourth lens group is changed, and wherein at least part of the fourth lens group moves so as to include a component in a direction orthogonal to an optical axis. Thereby, it is possible to correct image blur arising from camera shake, vibration, and the like, that is, it is possible to perform vibration reduction, and specifically, it is possible to achieve a satisfactory optical performance even during vibration reduction while downsizing a lens barrel.

In the embodiments, it can be preferable that the variable magnification optical system include: in order from an object, a first lens group having a positive refractive power; a second lens group (negative lens group) having a negative refractive power; a third lens group having a positive refractive power; and a fourth lens group (positive lens group) having a positive refractive power, wherein when varying magnification, the distance between the first lens group and the second lens group is changed, the distance between the second lens group and the third lens group is changed, and the distance between the third lens group and the fourth lens group is changed, and wherein Conditional Expression (4) below is satisfied.

0.10<ff/f4<0.90 (4)

where

ff: a focal length of the third lens group, and

f4: a focal length of the fourth lens group.

Conditional Expression (4) is a conditional expression for defining a ratio of the focal length of the third lens group to the focal length of the fourth lens group. In the variable magnification optical system, when Conditional Expression (4) is satisfied, it is possible to satisfactorily correct spherical aberration, coma aberration, and astigmatism in the telephoto end state.

In the variable magnification optical system, when the correspondence value of Conditional Expression (4) is smaller than the lower limit value, the refractive power of the third lens group becomes large. Thereby, it becomes difficult to correct spherical aberration and coma aberration in the telephoto end state, and therefore, this is not preferable. In order to reliably obtain the effect, the lower limit value of Conditional Expression (4) can be preferably 0.20. In order to further reliably obtain the effect, the lower limit value of Conditional Expression (4) can be preferably 0.24.

On the other hand, in the variable magnification optical system, when the correspondence value of Conditional Expression (4) exceeds the upper limit value, the refractive power of the fourth lens group becomes large. Thereby, it becomes difficult to correct coma aberration and astigmatism in the telephoto end state, and therefore, this is not preferable. In order to reliably obtain the effect, the upper limit value of Conditional Expression (4) can be preferably 0.75. In order to further reliably obtain the effect, the upper limit value of Conditional Expression (4) can be preferably 0.64.

In the embodiments, it can be preferable that the variable magnification optical system include: in order from an object, a first lens group having a positive refractive power; a second lens group (negative lens group) having a negative refractive power; and a third lens group having a positive refractive power, wherein when varying magnification, the distance between the first lens group and the second lens group is changed, and the distance between the second lens group and the third lens group is changed, and wherein Conditional Expression (5) below is satisfied.

60.00<vd 3 (5)

where

vd3: the Abbe number of the single lens included in the third lens group.

Conditional Expression (5) is a conditional expression for defining the Abbe number of the single lens in the third lens group. In the variable magnification optical system, when Conditional Expression (5) is satisfied, it is possible to satisfactorily correct on-axis chromatic aberration and spherical aberration in the telephoto end state.

In the variable magnification optical system, when the correspondence value of Conditional Expression (5) is smaller than the lower limit value, it becomes difficult to correct on-axis chromatic aberration and spherical aberration in the telephoto end state, and therefore, this is not preferable. In order to reliably obtain the effect, the lower limit value of Conditional Expression (5) can be preferably 63.00. In order to further reliably obtain the effect, the lower limit value of Conditional Expression (5) can be preferably 64.00.

In an embodiment, the optical apparatus includes the variable magnification optical system having the configuration described above. Thereby, it is possible to realize an optical apparatus having a satisfactory optical performance.

In an embodiment, a variable magnification optical system manufacturing method is a manufacturing method of a variable magnification optical system, including: a first lens group having a positive refractive power and arranged closest to an object; a negative lens group having a negative refractive power and arranged closer to an image than the first lens group; and a focusing group arranged between the negative lens group and an aperture stop, the method including: arranging, when varying magnification, such that the distance between the first lens group and the negative lens group is changed, and the distance between the negative lens group and the aperture stop is changed; arranging, when focusing, such that the distance between the focusing group and a lens arranged at a position to face an object-side of the focusing group is changed, and the distance between the focusing group and a lens arranged at a position to face an image-side of the focusing group is changed; and configuring such that the focusing group is constituted by one single lens having a positive refractive power, wherein Conditional Expression (1) below is satisfied. Thereby, it is possible to manufacture a variable magnification optical system having a satisfactory optical performance.

1.40<f1/ff<2.20 (1)

where

f1: a focal length of the first lens group, and

ff: a focal length of the focusing group.

In an alternative embodiment, a variable magnification optical system manufacturing method is a manufacturing method of a variable magnification optical system, including: in order from an object, a first lens group having a positive refractive power; a second lens group having a negative refractive power; a third lens group having a positive refractive power; and a fourth lens group having a positive refractive power, the method including: causing the third lens group to be constituted by one single lens having a positive refractive power; causing the variable magnification optical system to satisfy Conditional Expression (1) below; and when varying magnification from a wide-angle end state to a telephoto end state, changing the distance between the lens groups. Thereby, it is possible to manufacture a variable magnification optical system having a satisfactory optical performance.

1.40<f1/ff<2.20 (1)

where

f1: a focal length of the first lens group, and

ff: a focal length of the third lens group.

Hereinafter, a variable magnification optical system according to numerical examples is described with reference to the accompanied drawings.

### Example 1

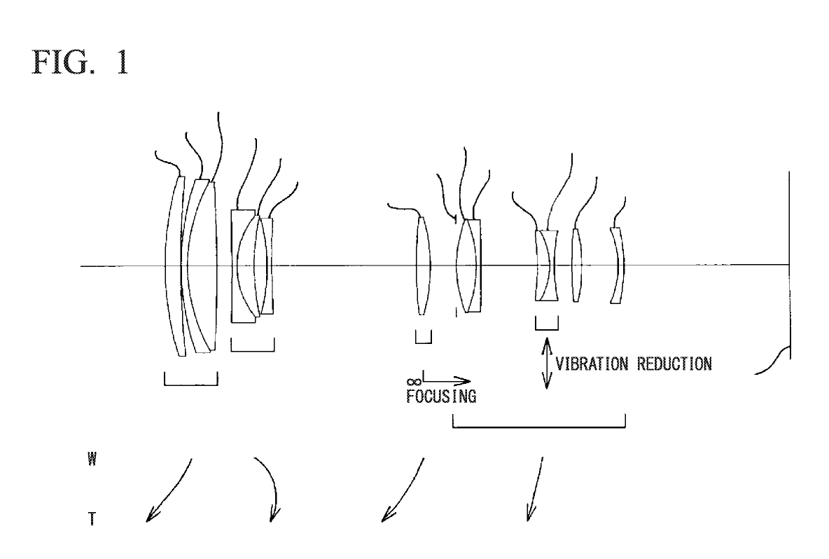

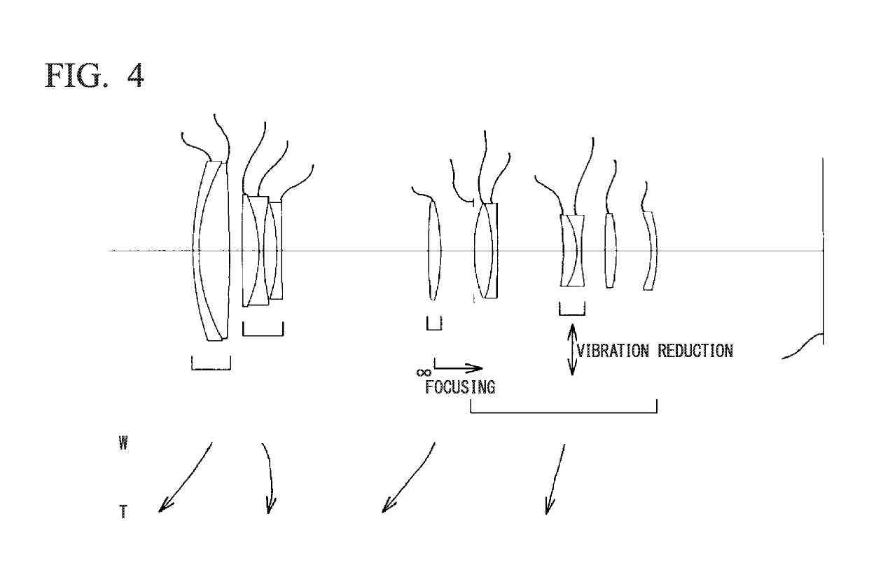

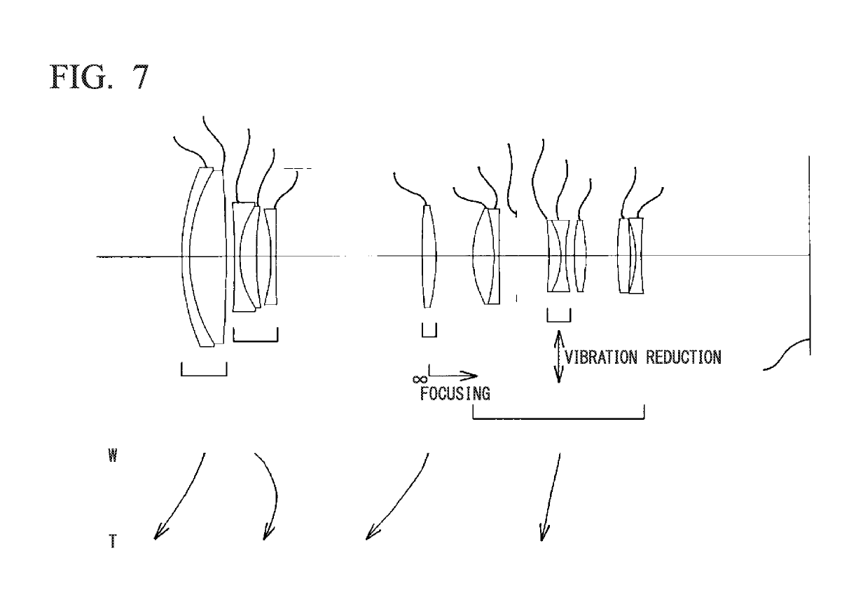

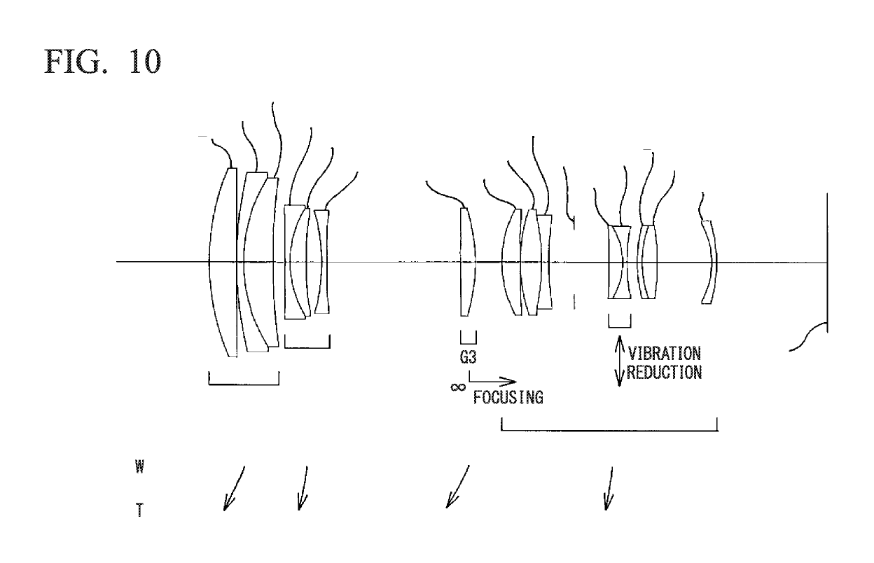

FIG. 1 is a cross-sectional view of a variable magnification optical system according to Example 1 in a wide-angle end state. Arrows in FIG. 1 and FIG. 4, FIG. 7, and FIG. 10 described below indicate a movement trajectory of the lens groups when varying magnification from a wide-angle end state (W) to a telephoto end state (T).

A variable magnification optical system according to the present Example is constituted by: in order from an object, a first lens group G1 having a positive refractive power; a second lens group G2 having a negative refractive power; a third lens group G3 having a positive refractive power; and a fourth lens group G4 having a positive refractive power.

The first lens group G1 is constituted by, in order from the object, a positive meniscus lens L11 having a convex surface oriented toward the object and a cemented lens that includes a negative meniscus lens L12 having a convex surface oriented toward the object and a positive lens L13 having a biconvex shape.

The second lens group G2 is constituted by, in order from the object, a cemented lens that includes a negative lens L21 having a biconcave shape and a positive meniscus lens L22 having a convex surface oriented toward the object and a negative lens L23 having a biconcave shape.

The third lens group G3 is constituted by a positive lens L31 having a biconvex shape.

The fourth lens group G4 is constituted by, in order from the object, an aperture stop S, a cemented lens that includes a positive lens L41 having a biconvex shape and a negative meniscus lens L42 having a convex surface oriented toward the image, a cemented lens that includes a positive meniscus lens L43 having a convex surface oriented toward the image and a negative lens L44 having a biconcave shape, a positive lens L45 having a biconvex shape, and a negative meniscus lens L46 having a convex surface oriented toward the image.

In the variable magnification optical system according to the present Example having the above configuration, when varying magnification from the wide-angle end state to the telephoto end state, each of the first to fourth lens groups G1 to G4 is moved along the optical axis such that the air distance between the first lens group G1 and the second lens group G2 is changed, the air distance between the second lens group G2 and the third lens group G3 is changed, and the air distance between the third lens group G3 and the fourth lens group G4 is changed.

In the variable magnification optical system according to the present Example, focusing from an object at infinity to an object at a close distance is performed by moving the third lens group G3 toward the image along the optical axis.

In the variable magnification optical system according to the present Example, vibration reduction is performed by moving the cemented lens that includes the positive meniscus lens L43 and the negative lens L44 in the fourth lens group G4 so as to include a component in a direction orthogonal to the optical axis. Table 1 below shows values of specifications of the variable magnification optical system according to the present Example.

In Table 1, “f” indicates the focal length, and “Bf” indicates the back focus (distance on the optical axis between a lens surface closest to the image and an image plane I).

In [Surface Data], a “surface number” indicates a sequence number of an optical surface counted from the object side, “r” indicates the radius of curvature, “d” indicates the surface distance (distance between an n-th surface (n is an integer) and an (n+1)-th surface), “nd” indicates the refractive index for the d-line (wavelength: 587.6 nm), and “vd” indicates the Abbe number for the d-line (wavelength: 587.6 nm). Moreover, an “object plane” indicates the object plane, “variable” indicates a variable distance between surfaces, an “aperture stop S” indicates the aperture stop S, and an “image plane” indicates the image plane I. The radius of curvature “r=∞” indicates a flat surface.

In [Various Data], “FNO” indicates the F-number, “ω” indicates a half-angle of view (unit: “°”), “Y” indicates the image height, “TL” indicates the entire length (distance on the optical axis from a first surface to the image plane I) of the variable magnification optical system according to the present Example, and “dn” indicates a variable distance between the n-th surface and the (n+1)-th surface. “W” indicates the wide-angle end state, “M” indicates the intermediate focal length state, and “T” indicates the telephoto end state. “d0” indicates the distance from the object to the first surface.

In [Lens Group Data], the starting surface and the focal length of each lens group are shown.

In [Conditional Expression Correspondence Values], the correspondence values of each conditional expression of the variable magnification optical system according to the present Example are shown.

“mm” is generally used as the unit of the focal length f, the radius of curvature r, and other lengths shown in Table 1. However, the unit is not limited to this since an equivalent optical performance is obtained even when the optical system is proportionally expanded or proportionally reduced.

The same symbols as in Table 1 described above are used in Tables of other examples to be described later.

TABLE 1
Example 1
[Surface Data]

| Surface number | r | d | nd | νd |
|---|---|---|---|---|
| Object plane | ∞ | | | |
| 1 | 71.181 | 3.783 | 1.51680 | 63.88 |
| 2 | 215.901 | 0.095 | 1.00000 | |
| 3 | 63.130 | 1.500 | 1.78472 | 25.64 |
| 4 | 39.888 | 7.004 | 1.48749 | 70.31 |
| 5 | −337.340 | Variable | | |
| 6 | −522.329 | 1.200 | 1.72916 | 54.61 |
| 7 | 18.825 | 4.059 | 1.80518 | 25.45 |
| 8 | 50.914 | 3.117 | 1.00000 | |
| 9 | −43.738 | 1.100 | 1.80400 | 46.60 |
| 10 | 217.724 | Variable | | |
| 11 | 94.133 | 3.391 | 1.49782 | 82.57 |
| 12 | −41.765 | Variable | | |
| 13(Aperture stop S) | ∞ | 0.100 | 1.00000 | |
| 14 | 29.229 | 4.644 | 1.56384 | 60.71 |
| 15 | −31.326 | 1.100 | 1.80518 | 25.45 |
| 16 | −2034.980 | 13.423 | 1.00000 | |
| 17 | −65.010 | 2.981 | 1.85026 | 32.35 |
| 18 | −15.931 | 1.100 | 1.75500 | 52.34 |
| 19 | 42.547 | 4.150 | 1.00000 | |
| 20 | 95.432 | 2.397 | 1.77250 | 49.62 |
| 21 | −36.738 | 8.561 | 1.00000 | |
| 22 | −22.000 | 1.400 | 1.80100 | 34.92 |
| 23 | −39.498 | Bf | | |
| Image plane | ∞ | | | |

[Various Data]
Variable Magnification Ratio: 3.43

| | W | T |
|---|---|---|
| f | 56.59 | 193.99 |
| FNO | 4.12 | 5.80 |
| ω | 14.31° | 4.06° |
| Y | 14.00 | 14.00 |
| TL | 148.31 | 170.32 |
| Bf | 39.30 | 63.82 |

<When Focusing Object at Infinity>

| | W | M | T |
|---|---|---|---|
| d0 | ∞ | ∞ | ∞ |
| d5 | 3.619 | 23.832 | 27.378 |
| d10 | 34.229 | 11.631 | 1.500 |
| d12 | 6.050 | 10.275 | 12.507 |

<When Focusing Object at Close Distance (Imaging distance: 1.5 m)>

| | W | M | T |
|---|---|---|---|
| d0 | 1351.68 | 1337.34 | 1329.67 |
| d5 | 3.619 | 23.832 | 27.378 |
| d10 | 36.680 | 18.152 | 9.762 |
| d12 | 3.599 | 3.753 | 4.244 |

[Lens Group Data]

| Group | Starting surface | f |
|---|---|---|
| 1 | 1 | 89.021 |
| 2 | 6 | −27.756 |
| 3 | 11 | 58.599 |
| 4 | 13 | 165.813 |

[Conditional Expression Correspondence Values]

| | |
|---|---|
| (1) f1/ff | = 1.52 |
| (2) f1/(−f2) | = 3.21 |
| (3) ff/(−f2) | = 2.11 |
| (4) ff/f4 | = 0.35 |
| (5) νd3 | = 82.57 |

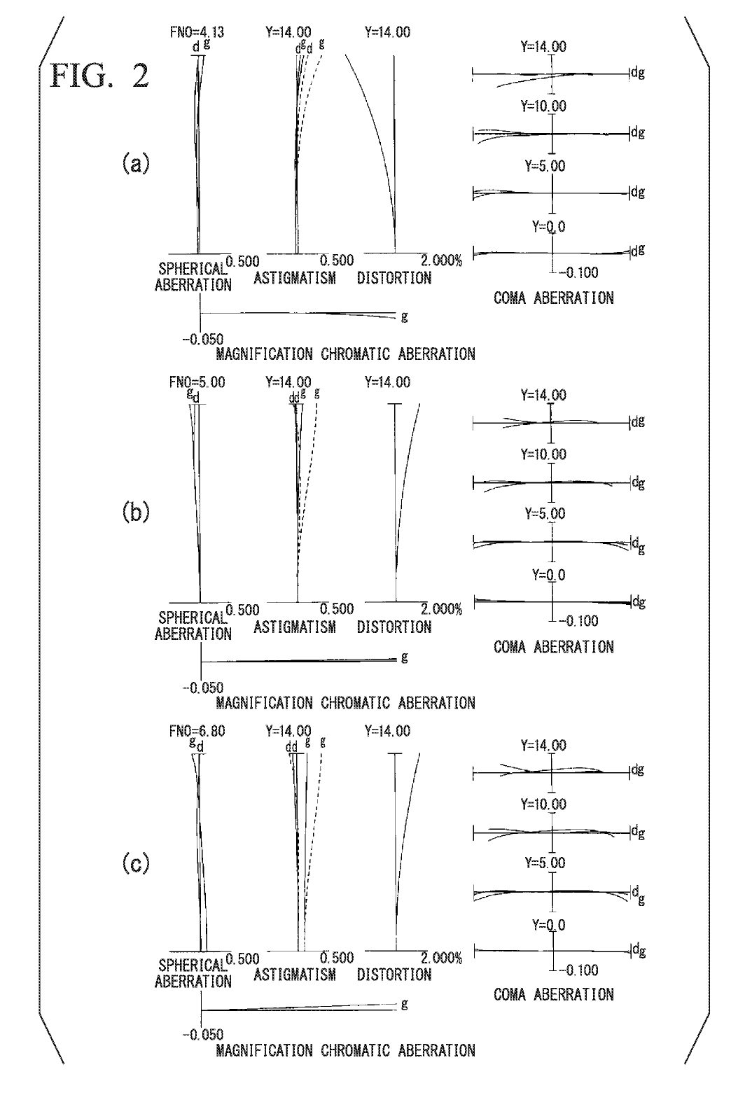

FIG. 2 shows graphs of various aberrations of the variable magnification optical system according to Example 1 when focusing an object at infinity. Part (a) of FIG. 2 shows various aberrations in a wide-angle end state. Part (b) of FIG. 2 shows various aberrations in an intermediate focal length state. Part (c) of FIG. 2 shows various aberrations in a telephoto end state.

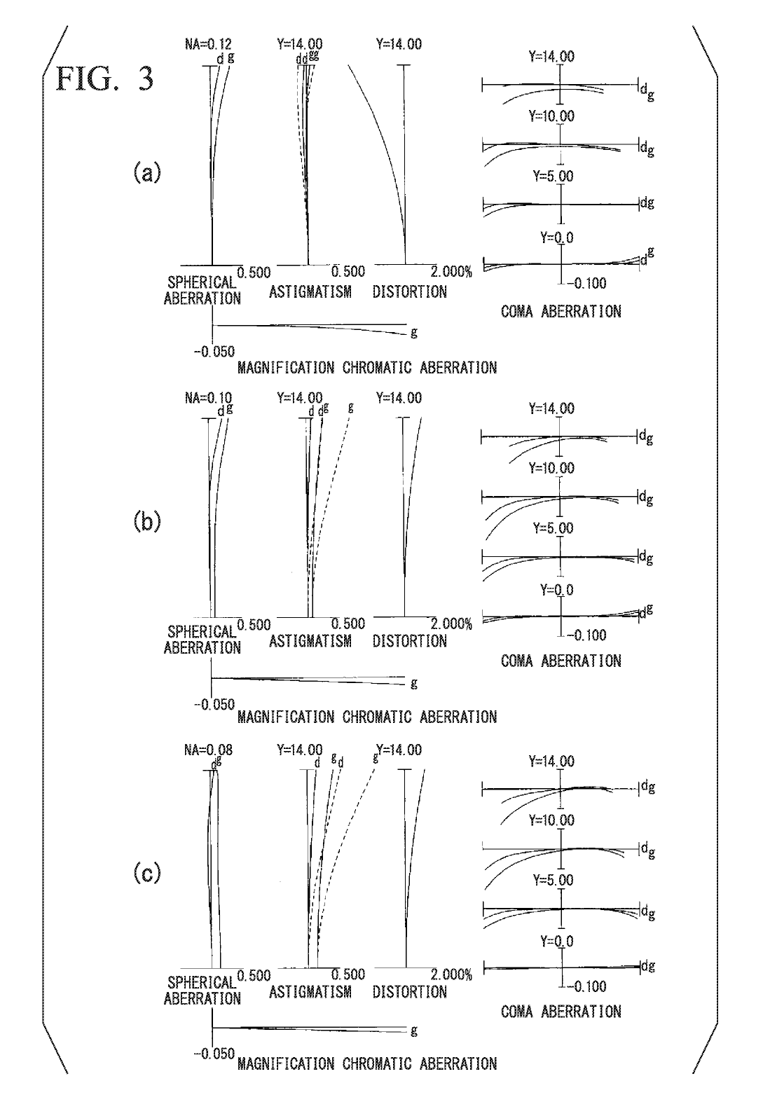

FIG. 3 shows graphs of various aberrations of the variable magnification optical system according to Example 1 when focusing an object at a close distance. Part (a) of FIG. 3 shows various aberrations in the wide-angle end state. Part (b) of FIG. 3 shows various aberrations in the intermediate focal length state. Part (c) of FIG. 3 shows various aberrations in the telephoto end state.

In the graphs showing aberrations, “FNO” indicates the F-number, “Y” indicates the image height, and “NA” indicates a numerical aperture. In detail, in the graphs showing spherical aberration, values of the F-number FNO or the numerical aperture NA corresponding to the maximum aperture are shown, in the graphs showing astigmatism and the graphs showing distortion, maximum values of the image height Y are shown, and in the graphs showing coma aberration, values of each image height are shown. In the graphs showing aberration, “d” indicates aberration for the d-line (wavelength: 587.6 nm), and “g” indicates aberration for the g-line (wavelength: 435.8 nm). In the graphs showing astigmatism, a solid line indicates a sagittal image plane, and a broken line indicates a meridional image plane. In the graphs showing coma aberration, coma aberration at each image height Y is shown. The same reference symbols as the present Example are used in the aberration graphs of examples to be described later.

It can be understood from the aberration graphs that various aberrations are satisfactorily corrected, and the variable magnification optical system according to the present Example has an excellent imaging performance.

### Example 2

FIG. 4 is a cross-sectional view of a variable magnification optical system according to Example 2 in a wide-angle end state.

A variable magnification optical system according to the present Example is constituted by: in order from an object, a first lens group G1 having a positive refractive power; a second lens group G2 having a negative refractive power; a third lens group G3 having a positive refractive power; and a fourth lens group G4 having a positive refractive power.

The first lens group G1 is constituted by, in order from the object, a cemented lens that includes a negative meniscus lens L11 having a convex surface oriented toward the object and a positive lens L12 having a biconvex shape.

The second lens group G2 is constituted by, in order from the object, a cemented lens that includes a positive lens L21 having a biconvex shape and a negative lens L22 having a biconcave shape and a negative lens L23 having a biconcave shape.

The third lens group G3 is constituted by a positive lens L31 having a biconvex shape.

The fourth lens group G4 is constituted by, in order from the object, an aperture stop S, a cemented lens that includes a positive lens L41 having a biconvex shape and a negative meniscus lens L42 having a convex surface oriented toward the image, a cemented lens that includes a positive meniscus lens L43 having a convex surface oriented toward the image and a negative lens L44 having a biconcave shape, a positive lens L45 having a biconvex shape, and a negative meniscus lens L46 having a convex surface oriented toward the image.

In the variable magnification optical system according to the present Example having the above configuration, when varying magnification from the wide-angle end state to the telephoto end state, each of the first to fourth lens groups G1 to G4 is moved along the optical axis such that the air distance between the first lens group G1 and the second lens group G2 is changed, the air distance between the second lens group G2 and the third lens group G3 is changed, and the air distance between the third lens group G3 and the fourth lens group G4 is changed.

In the variable magnification optical system according to the present Example, focusing from an object at infinity to an object at a close distance is performed by moving the third lens group G3 toward the image along the optical axis.

In the variable magnification optical system according to the present Example, vibration reduction is performed by moving the cemented lens that includes the positive meniscus lens L43 and the negative lens L44 in the fourth lens group G4 so as to include a component in a direction orthogonal to the optical axis.

Table 2 below shows values of specifications of the variable magnification optical system according to the present Example.

TABLE 2
Example 2
[Surface Data]

| Surface number | r | d | nd | νd |
|---|---|---|---|---|
| Object plane | ∞ | | | |
| 1 | 63.095 | 1.500 | 1.80518 | 25.45 |
| 2 | 41.791 | 7.123 | 1.58913 | 61.22 |
| 3 | −386.418 | Variable | | |
| 4 | 479.014 | 3.954 | 1.80518 | 25.45 |
| 5 | −32.519 | 1.100 | 1.72916 | 54.61 |
| 6 | 59.138 | 3.181 | 1.00000 | |
| 7 | −37.896 | 1.100 | 1.80400 | 46.60 |
| 8 | 743.156 | Variable | | |
| 9 | 114.932 | 2.900 | 1.49782 | 82.57 |
| 10 | −47.146 | Variable | | |
| 11(Aperture stop S) | ∞ | 0.100 | 1.00000 | |
| 12 | 32.029 | 4.395 | 1.60300 | 65.44 |
| 13 | −34.300 | 1.100 | 1.80518 | 25.45 |
| 14 | −459.609 | 15.385 | 1.00000 | |
| 15 | −63.416 | 3.199 | 1.85026 | 32.35 |
| 16 | −16.491 | 1.100 | 1.75500 | 52.34 |
| 17 | 44.329 | 5.586 | 1.00000 | |
| 18 | 92.872 | 2.697 | 1.71999 | 50.26 |
| 19 | −40.382 | 8.116 | 1.00000 | |
| 20 | −22.000 | 1.400 | 1.80100 | 34.92 |
| 21 | −35.076 | Bf | | |
| Image plane | ∞ | | | |

[Various Data]
Variable Magnification Ratio: 3.43

| | W | T |
|---|---|---|
| f | 56.60 | 194.00 |
| FNO | 4.12 | 5.86 |
| ω | 14.25° | 4.06° |
| Y | 14.00 | 14.00 |
| TL | 148.32 | 180.32 |
| Bf | 39.01 | 65.83 |

<When Focusing Object at Infinity>

| | W | M | T |
|---|---|---|---|
| d0 | ∞ | ∞ | ∞ |
| d3 | 3.000 | 31.280 | 36.518 |
| d8 | 34.644 | 12.104 | 1.500 |
| d10 | 7.717 | 12.876 | 12.530 |

<When Focusing Object at Close Distance (Imaging distance: 1.5 m)>

| | W | M | T |
|---|---|---|---|
| d0 | 1351.67 | 1327.14 | 1319.67 |
| d3 | 3.000 | 31.280 | 36.518 |
| d8 | 36.933 | 18.430 | 9.778 |
| d10 | 5.427 | 6.550 | 4.252 |

[Lens Group Data]

| Group | Starting surface | f |
|---|---|---|
| 1 | 1 | 109.858 |
| 2 | 4 | −32.251 |
| 3 | 9 | 67.558 |
| 4 | 11 | 127.122 |

[Conditional Expression Correspondence Values]

| | |
|---|---|
| (1) f1/ff | = 1.63 |
| (2) f1/(−f2) | = 3.41 |
| (3) ff/(−f2) | = 2.09 |
| (4) ff/f4 | = 0.53 |
| (5) νd3 | = 82.57 |

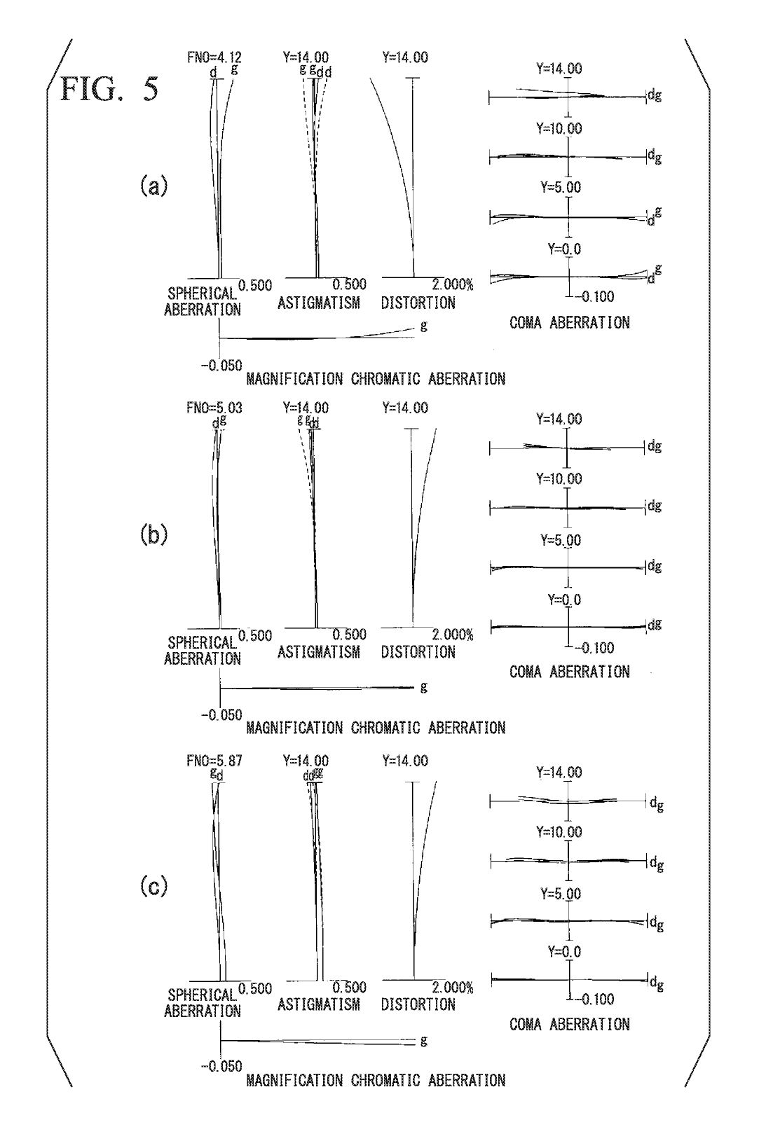

FIG. 5 shows graphs of various aberrations of the variable magnification optical system according to Example 2 when focusing an object at infinity. Part (a) of FIG. 5 shows various aberrations in a wide-angle end state. Part (b) of FIG. 5 shows various aberrations in an intermediate focal length state. Part (c) of FIG. 5 shows various aberrations in a telephoto end state.

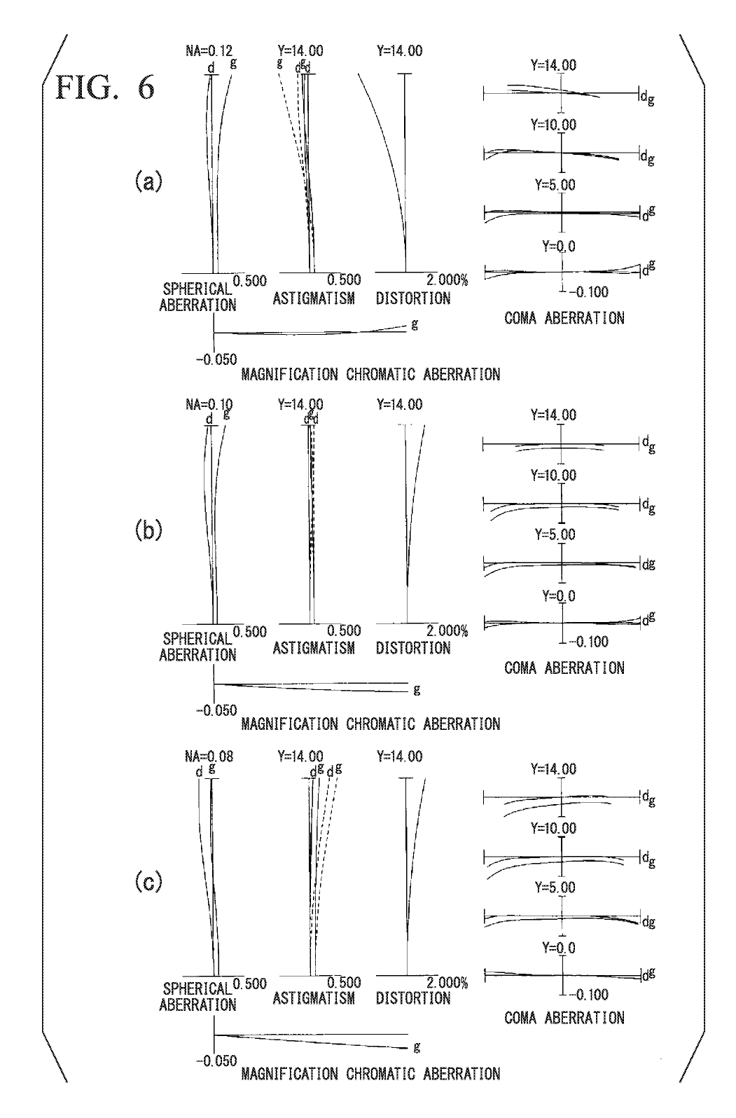

FIG. 6 shows graphs of various aberrations of the variable magnification optical system according to Example 2 when focusing an object at a close distance. Part (a) of FIG. 6 shows various aberrations in the wide-angle end state. Part (b) of FIG. 6 shows various aberrations in the intermediate focal length state. Part (c) of FIG. 6 shows various aberrations in the telephoto end state.

It can be understood from the aberration graphs that various aberrations are satisfactorily corrected, and the variable magnification optical system according to the present Example has an excellent imaging performance.

### Example 3

FIG. 7 is a cross-sectional view of a variable magnification optical system according to Example 3 in a wide-angle end state.

A variable magnification optical system according to the present Example is constituted by: in order from an object, a first lens group G1 having a positive refractive power; a second lens group G2 having a negative refractive power; a third lens group G3 having a positive refractive power; and a fourth lens group G4 having a positive refractive power.

The first lens group G1 is constituted by, in order from the object, a cemented lens that includes a negative meniscus lens L11 having a convex surface oriented toward the object and a positive lens L12 having a biconvex shape.

The second lens group G2 is constituted by, in order from the object, a cemented lens that includes a negative lens L21 having a biconcave shape and a positive meniscus lens L22 having a convex surface oriented toward the object and a negative lens L23 having a biconcave shape.

The third lens group G3 is constituted by a positive lens L31 having a biconvex shape.

The fourth lens group G4 is constituted by, in order from the object, a cemented lens that includes a positive lens L41 having a biconvex shape and a negative lens L42 having a biconcave shape, an aperture stop S, a cemented lens that includes a positive meniscus lens L43 having a convex surface oriented toward the image and a negative lens L44 having a biconcave shape, a positive lens L45 having a biconvex shape, a positive lens L46 having a biconvex shape, and a negative lens L47 having a biconcave shape.

In the variable magnification optical system according to the present Example having the above configuration, when varying magnification from the wide-angle end state to the telephoto end state, each of the first to fourth lens groups G1 to G4 is moved along the optical axis such that the air distance between the first lens group G1 and the second lens group G2 is changed, the air distance between the second lens group G2 and the third lens group G3 is changed, and the air distance between the third lens group G3 and the fourth lens group G4 is changed.

In the variable magnification optical system according to the present Example, focusing from an object at infinity to an object at a close distance is performed by moving the third lens group G3 toward the image along the optical axis.

In the variable magnification optical system according to the present Example, vibration reduction is performed by moving the cemented lens that includes the positive meniscus lens L43 and the negative lens L44 in the fourth lens group G4 so as to include a component in a direction orthogonal to the optical axis.

Table 3 below shows values of specifications of the variable magnification optical system according to the present Example.

TABLE 3
Example 3
[Surface Data]

| Surface number | r | d | nd | νd |
|---|---|---|---|---|
| Object plane | ∞ | | | |
| 1 | 52.406 | 1.800 | 1.80518 | 25.45 |
| 2 | 38.475 | 8.542 | 1.48749 | 70.31 |
| 3 | −284.767 | Variable | | |
| 4 | −199.633 | 1.200 | 1.79500 | 45.31 |
| 5 | 20.975 | 3.861 | 1.80518 | 25.45 |
| 6 | 77.691 | 3.309 | 1.00000 | |
| 7 | −41.578 | 1.200 | 1.60300 | 65.44 |
| 8 | 934.959 | Variable | | |
| 9 | 132.334 | 3.206 | 1.60300 | 65.44 |
| 10 | −49.998 | Variable | | |
| 11 | 23.991 | 4.868 | 1.49782 | 82.57 |
| 12 | −45.086 | 1.100 | 1.84666 | 23.80 |
| 13 | 540.330 | 4.000 | 1.00000 | |
| 14(Aperture stop S) | ∞ | 7.518 | 1.00000 | |
| 15 | −65.783 | 2.726 | 1.90366 | 31.27 |
| 16 | −17.427 | 1.100 | 1.77250 | 49.62 |
| 17 | 36.809 | 2.000 | 1.00000 | |
| 18 | 43.409 | 2.613 | 1.58913 | 61.22 |
| 19 | −46.365 | 7.365 | 1.00000 | |
| 20 | 65.436 | 2.969 | 1.51823 | 58.82 |
| 21 | −74.103 | 1.270 | 1.00000 | |
| 22 | −22.594 | 1.300 | 1.48749 | 70.31 |
| 23 | 90.297 | Bf | | |
| Image plane | ∞ | | | |

[Various Data]
Variable Magnification Ratio: 3.43

| | W | T |
|---|---|---|
| f | 56.60 | 194.00 |
| FNO | 4.03 | 5.87 |
| ω | 14.30° | 4.06° |
| Y | 14.00 | 14.00 |
| TL | 145.47 | 177.47 |
| Bf | 39.01 | 65.81 |

<When Focusing Object at Infinity>

| | W | M | T |
|---|---|---|---|
| d0 | ∞ | ∞ | ∞ |
| d3 | 1.945 | 30.560 | 35.645 |
| d8 | 33.942 | 11.510 | 1.500 |
| d10 | 8.611 | 12.554 | 12.554 |

<When Focusing Object at Close Distance (Imaging distance: 1.5 m)>

| | W | M | T |
|---|---|---|---|
| d0 | 1354.52 | 1330.98 | 1322.52 |
| d3 | 1.945 | 30.560 | 35.645 |
| d8 | 36.720 | 18.240 | 9.780 |
| d10 | 5.834 | 5.824 | 4.273 |

[Lens Group Data]

| Group | Starting surface | f |
|---|---|---|
| 1 | 1 | 113.015 |
| 2 | 4 | −33.355 |
| 3 | 9 | 60.579 |
| 4 | 11 | 212.840 |

[Conditional Expression Correspondence Values]

| | |
|---|---|
| (1) f1/ff | = 1.87 |
| (2) f1/(−f2) | = 3.39 |
| (3) ff/(−f2) | = 1.82 |
| (4) ff/f4 | = 0.28 |
| (5) νd3 | = 65.44 |

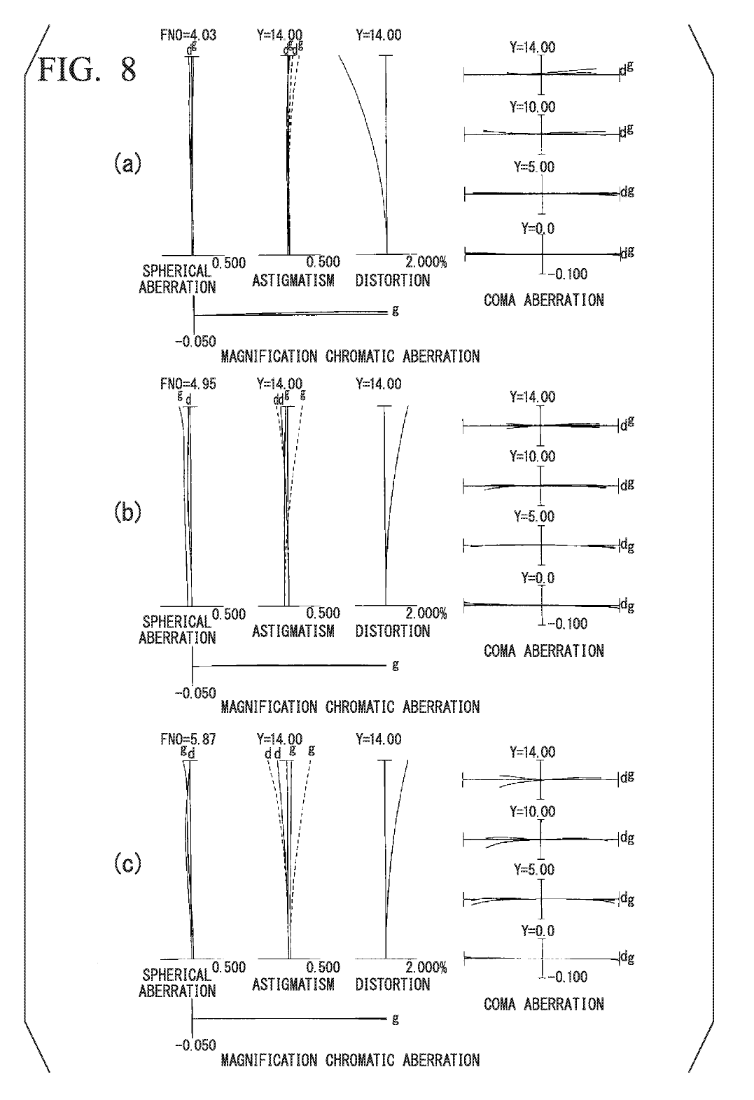

FIG. 8 shows graphs of various aberrations of the variable magnification optical system according to Example 3 when focusing an object at infinity. Part (a) of FIG. 8 shows various aberrations in a wide-angle end state. Part (b) of FIG. 8 shows various aberrations in an intermediate focal length state. Part (c) of FIG. 8 shows various aberrations in a telephoto end state.

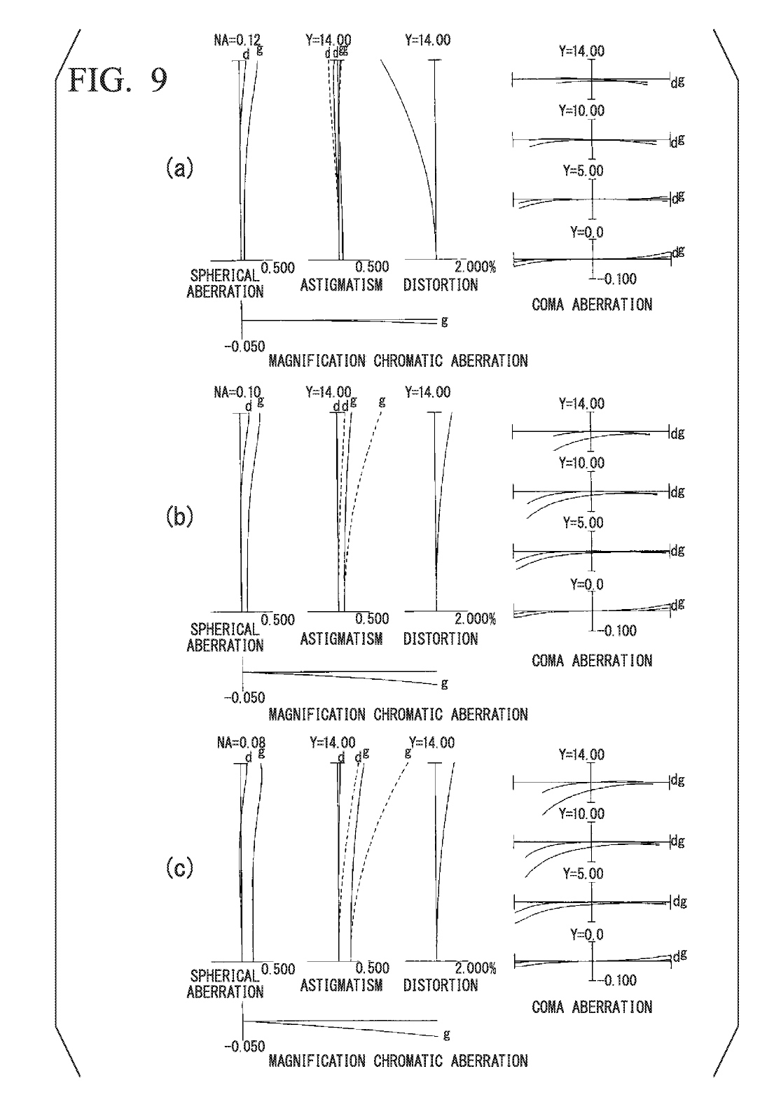

FIG. 9 shows graphs of various aberrations of the variable magnification optical system according to Example 3 when focusing an object at a close distance. Part (a) of FIG. 9 shows various aberrations in the wide-angle end state. Part (b) of FIG. 9 shows various aberrations in the intermediate focal length state. Part (c) of FIG. 9 shows various aberrations in the telephoto end state.

It can be understood from the aberration graphs that various aberrations are satisfactorily corrected, and the variable magnification optical system according to the present Example has an excellent imaging performance.

### Example 4

FIG. 10 is a cross-sectional view of a variable magnification optical system according to Example 4 in a wide-angle end state.

A variable magnification optical system according to the present Example is constituted by: in order from an object, a first lens group G1 having a positive refractive power; a second lens group G2 having a negative refractive power; a third lens group G3 having a positive refractive power; and a fourth lens group G4 having a positive refractive power.

The first lens group G1 is constituted by, in order from the object, a positive meniscus lens L11 having a convex surface oriented toward the object and a cemented lens that includes a negative meniscus lens L12 having a convex surface oriented toward the object and a positive meniscus lens L13 having a convex surface oriented toward the object.

The second lens group G2 is constituted by, in order from the object, a cemented lens that includes a negative lens L21 having a biconcave shape and a positive meniscus lens L22 having a convex surface oriented toward the object and a negative lens L23 having a biconcave shape.

The third lens group G3 is constituted by a positive lens L31 having a biconvex shape.

The fourth lens group G4 is constituted by, in order from the object, a positive meniscus lens L41 having a convex surface oriented toward the object, a cemented lens that includes a positive lens L42 having a biconvex shape and a negative lens L43 having a biconcave shape, an aperture stop S, a cemented lens that includes a positive meniscus lens L44 having a convex surface oriented toward the image and a negative lens L45 having a biconcave shape, a cemented lens that includes a negative meniscus lens L46 having a convex surface oriented toward the object and a positive lens L47 having a biconvex shape, and a negative meniscus lens L48 having a convex surface oriented toward the object.

In the variable magnification optical system according to the present Example having the above configuration, when varying magnification from the wide-angle end state to the telephoto end state, each of the first to fourth lens groups G1 to G4 is moved along the optical axis such that the air distance between the first lens group G1 and the second lens group G2 is changed, the air distance between the second lens group G2 and the third lens group G3 is changed, and the air distance between the third lens group G3 and the fourth lens group G4 is changed.

In the variable magnification optical system according to the present Example, focusing from an object at infinity to an object at a close distance is performed by moving the third lens group G3 toward the image along the optical axis.

In the variable magnification optical system according to the present Example, vibration reduction is performed by moving the cemented lens that includes the positive meniscus lens L44 and the negative lens L45 in the fourth lens group G4 so as to include a component in a direction orthogonal to the optical axis.

Table 4 below shows values of specifications of the variable magnification optical system according to the present Example.

TABLE 4
Example 4
[Surface Data]

| Surface number | r | d | nd | νd |
|---|---|---|---|---|
| Object plane | ∞ | | | |
| 1 | 51.1394 | 5.8000 | 1.487490 | 70.31 |
| 2 | 1133.2099 | 0.1000 | 1.000000 | |
| 3 | 82.0020 | 1.5000 | 1.672700 | 32.19 |
| 4 | 33.9780 | 6.2000 | 1.516800 | 63.88 |
| 5 | 133.9229 | Variable | | |
| 6 | −577.3429 | 1.0000 | 1.772500 | 49.62 |
| 7 | 21.5312 | 3.4000 | 1.846660 | 23.80 |
| 8 | 63.3609 | 3.4167 | 1.000000 | |
| 9 | −39.1089 | 1.0000 | 1.622990 | 58.12 |
| 10 | 126.2187 | Variable | | |
| 11 | 2276.1596 | 3.2242 | 1.603000 | 65.44 |
| 12 | −37.4736 | Variable | | |
| 13 | 23.6470 | 3.8000 | 1.487490 | 70.31 |
| 14 | 161.4472 | 0.1000 | 1.000000 | |
| 15 | 35.8671 | 4.4658 | 1.497820 | 82.57 |
| 16 | −50.2203 | 1.6000 | 1.902000 | 25.26 |
| 17 | 64.6451 | 5.3469 | 1.000000 | |
| 18(Aperture stop S) | ∞ | 7.4591 | 1.000000 | |
| 19 | −157.1854 | 2.9000 | 1.850260 | 32.35 |
| 20 | −14.7113 | 0.9000 | 1.795000 | 45.31 |
| 21 | 35.0299 | 2.2000 | 1.000000 | |
| 22 | 29.4465 | 1.0000 | 1.806100 | 40.97 |
| 23 | 21.3319 | 3.3000 | 1.603420 | 38.03 |
| 24 | −48.3688 | 11.6956 | 1.000000 | |
| 25 | −16.7768 | 1.0000 | 1.744000 | 44.81 |
| 26 | −31.2907 | Bf | | |
| Image plane | ∞ | | | |

[Various Data]
Variable Magnification Ratio: 3.43

| | W | M | T |
|---|---|---|---|
| f | 56.60 | 135.00 | 194.00 |
| FNO | 4.11 | 5.27 | 5.82 |
| ω | 14.23° | 5.84° | 4.07° |
| Y | 14.00 | 14.00 | 14.00 |
| TL | 131.99 | 157.03 | 166.71 |
| Bf | 23.64 | 39.59 | 52.68 |

<When Focusing Object at Infinity>

| | W | M | T |
|---|---|---|---|
| d0 | ∞ | ∞ | ∞ |
| d5 | 2.595 | 24.025 | 28.556 |
| d10 | 28.666 | 9.576 | 1.980 |
| d12 | 5.674 | 12.431 | 12.086 |

<When Focusing Object at Close Distance (Imaging distance: 1.5 m)>

| | W | M | T |
|---|---|---|---|
| d0 | 1368.01 | 1342.97 | 1333.288 |
| d5 | 2.595 | 24.025 | 28.5560 |
| d10 | 30.970 | 14.542 | 8.1859 |
| d12 | 3.371 | 7.464 | 5.8803 |

[Lens Group Data]

| Group | Starting surface | f |
|---|---|---|
| 1 | 1 | 108.548 |
| 2 | 6 | −30.400 |
| 3 | 11 | 61.171 |
| 4 | 13 | 141.532 |

[Conditional Expression Correspondence Values]

| | |
|---|---|
| (1) f1/ff | = 1.77 |
| (2) f1/(−f2) | = 3.57 |
| (3) ff/(−f2) | = 2.01 |
| (4) ff/f4 | = 0.43 |
| (5) νd3 | = 65.44 |

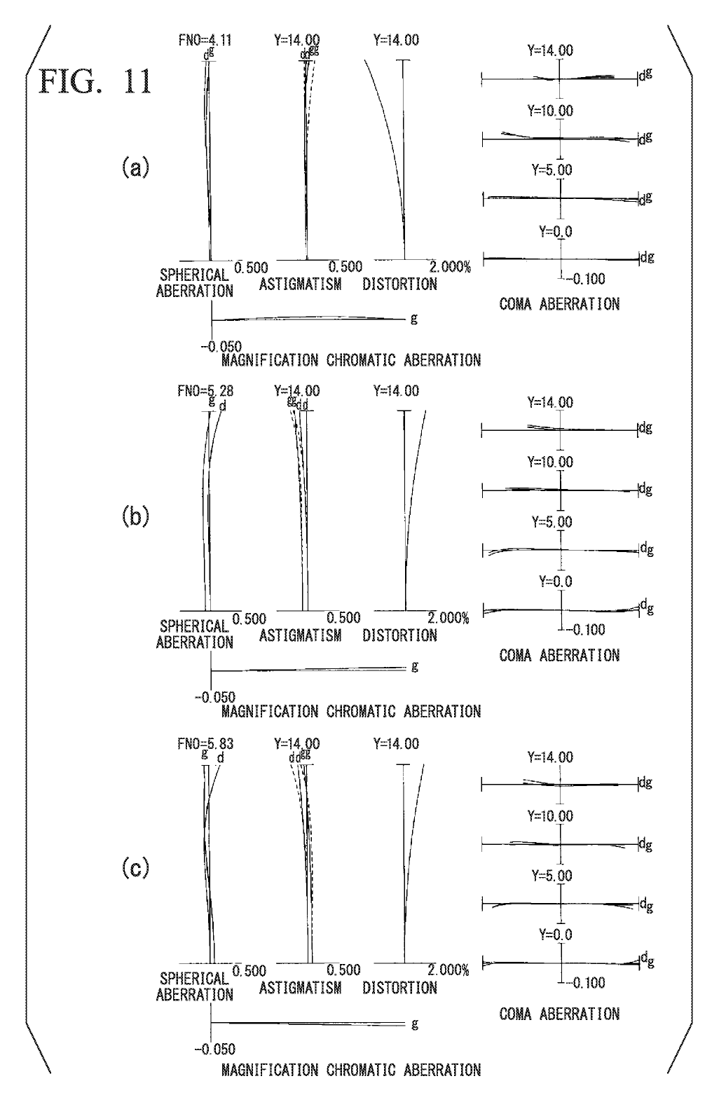

FIG. 11 shows graphs of various aberrations of the variable magnification optical system according to Example 4 when focusing an object at infinity. Part (a) of FIG. 11 shows various aberrations in a wide-angle end state. Part (b) of FIG. 11 shows various aberrations in an intermediate focal length state. Part (c) of FIG. 11 shows various aberrations in a telephoto end state.

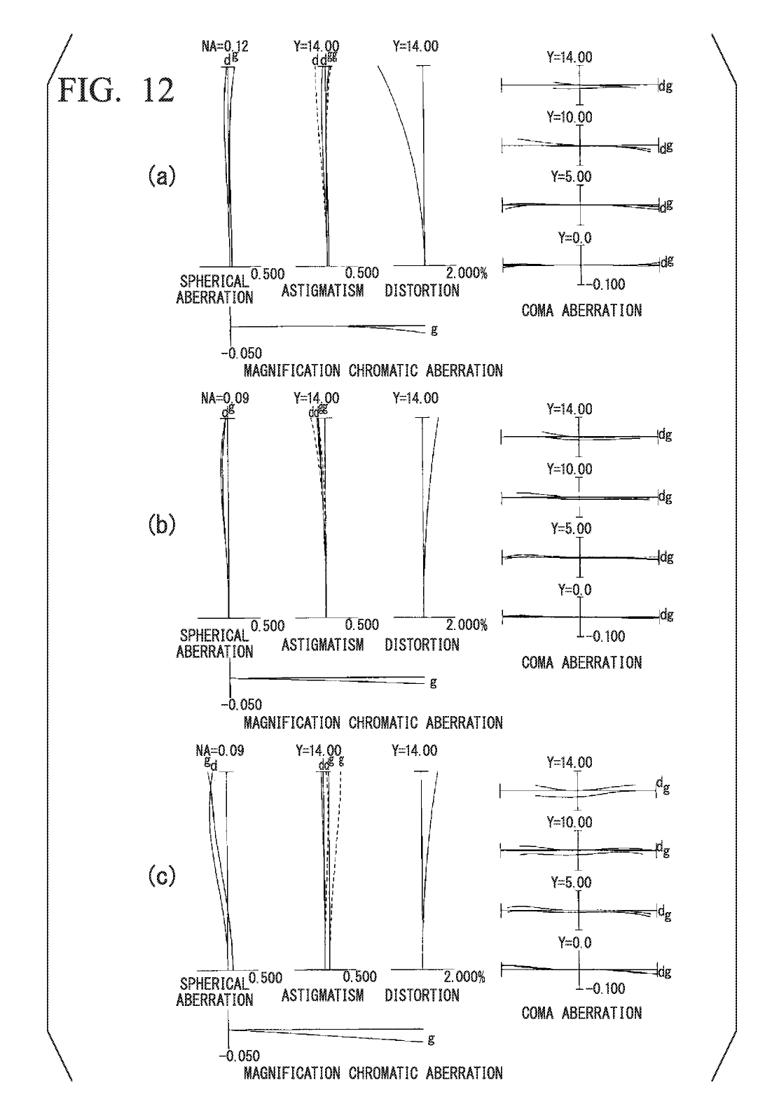

FIG. 12 shows graphs of various aberrations of the variable magnification optical system according to Example 4 when focusing an object at a close distance. Part (a) of FIG. 12 shows various aberrations in the wide-angle end state. Part (b) of FIG. 12 shows various aberrations in the intermediate focal length state. Part (c) of FIG. 12 shows various aberrations in the telephoto end state.

It can be understood from the aberration graphs that various aberrations are satisfactorily corrected, and the variable magnification optical system according to the present Example has an excellent imaging performance.

According to the examples described above, it is possible to realize a variable magnification optical system having a satisfactory optical performance while including a vibration reduction function. The examples described above show specific examples of the present invention, but the present invention is not limited thereto. The following content can be appropriately employed within a range where the optical performance of the variable magnification optical system is not diminished.

Although the numerical examples of a four-group configuration have been shown as numerical examples of the variable magnification optical system, the present application is not limited thereto, and a configuration of a variable magnification optical system having another group configuration (for example, a five-group configuration and the like) can be employed. Specifically, a configuration in which a lens or a lens group is added at a position closest to an object or at a position closest to an image of the variable magnification optical system may be employed.

In order to perform focusing from an object at infinity to an object at a close distance, the variable magnification optical system has a configuration in which the third lens group that is constituted by one positive single lens is moved along the optical axis as the focusing group (focusing lens group). The focusing group described above can be applied to autofocus and is also suitable for driving based on an autofocus motor such as an ultrasonic motor and the like.

In the variable magnification optical system, a configuration can be adopted in which an entire arbitrary lens group or part of the lens group is moved as a vibration-reduction lens group so as to include a component in a direction orthogonal with respect to the optical axis or is rotated (oscillated) in an in-plane direction including the optical axis to thereby perform vibration reduction. Particularly, it can be preferable to use at least part of the fourth lens group as the vibration-reduction lens group in the variable magnification optical system.

The lens surface of a lens that constitutes the variable magnification optical system may be a spherical surface or a flat surface or may be an aspherical surface. When the lens surface is a spherical surface or a flat surface, it is possible to facilitate lens processing, assembly, and adjustment and to prevent degradation of optical performance due to errors in the lens processing, assembly and adjustment. Moreover, degradation of rendering performance is slight even when the image plane is shifted. When the lens surface is an aspherical surface, the aspherical surface may be any of an aspherical surface obtained by grinding, a glass-molded aspherical surface obtained by molding glass into an aspherical shape, and a composite aspherical surface obtained by forming a resin provided on a glass surface into an aspherical shape. Moreover, the lens surface may be a diffraction surface. The lens may be a refractive index-distributed lens (a GRIN lens) or a plastic lens.

It can be preferable that the aperture stop be arranged in the fourth lens group in the variable magnification optical system. The role of the aperture stop may be substituted by a lens frame without providing a member as the aperture stop.

An anti-reflection film having high transmittance in a wide wavelength range may be applied to a lens surface of a lens that constitutes the variable magnification optical system. Thereby, flare and ghosting are reduced, and it is possible to achieve high optical performance with a high contrast.

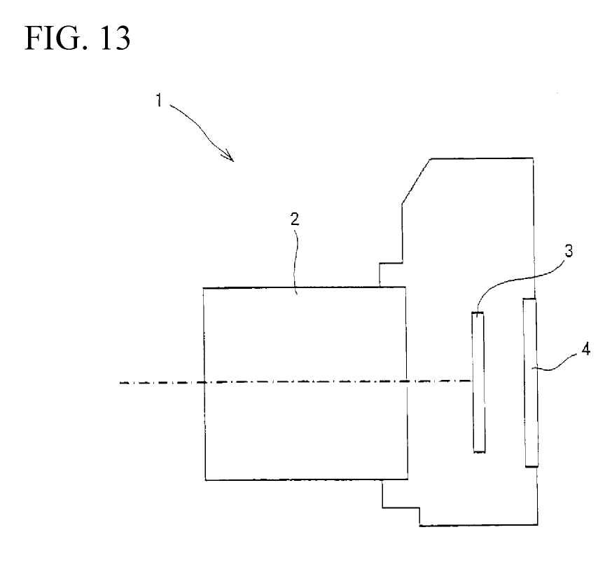

Next, an example of a camera including a variable magnification optical system is described with reference to FIG. 13.

FIG. 13 is a diagram showing a configuration of an example of a camera including a variable magnification optical system.

As shown in FIG. 13, a camera 1 is a so-called mirrorless camera with interchangeable lenses that includes the variable magnification optical system according to Example 1 described above as an image-capturing lens 2.

In the camera 1, light from an object (a subject) which is not shown is collected by the image-capturing lens 2 and forms a subject image on an image plane of an imaging unit 3 via an optical low-pass filter (OLPF) which is not shown. The subject image is photoelectrically converted by a photoelectric conversion element provided on the imaging unit 3, and the image of the subject is generated. This image is displayed on an electronic viewfinder (EVF) 4 provided on the camera 1. Thereby, a photographer can observe the subject via the EVF 4.

When a release button (not shown) is pressed by the photographer, the image of the subject generated by the imaging unit 3 is stored in a memory (not shown). In this way, the photographer can capture the image of the subject using the camera 1.

The variable magnification optical system according to Example 1 described above that is mounted on the camera 1 as the image-capturing lens 2 has a satisfactory optical performance. That is, the camera 1 can realize a satisfactory optical performance. A camera on which the variable magnification optical system according to Examples 2 to 4 described above is mounted as the image-capturing lens 2 can also provide effects similar to the camera 1 described above. Further, even when the variable magnification optical system according to the above-described examples is mounted on a single-lens reflex camera which has a quick return mirror and by which a subject is observed using a finder optical system, it is possible to obtain effects similar to the camera 1 described above.

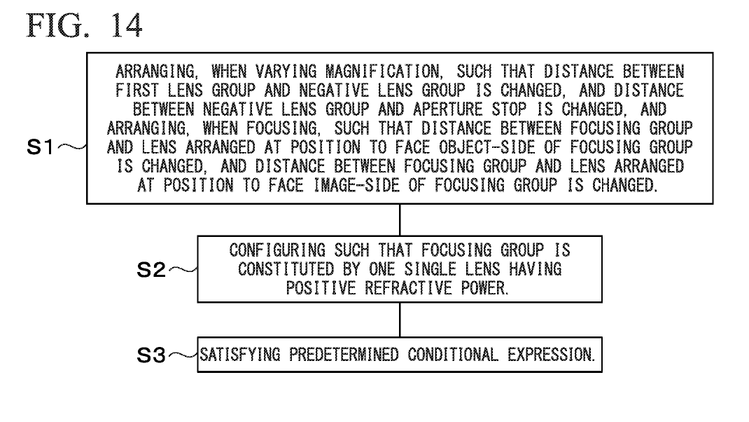

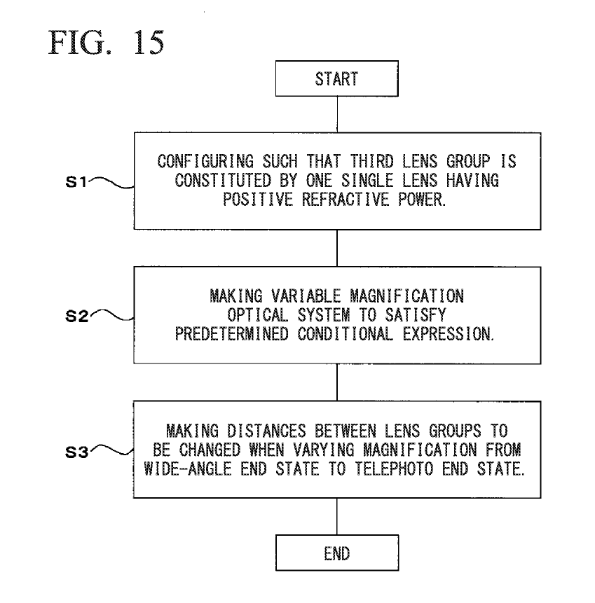

Finally, an overview of an example of a variable magnification optical system manufacturing method is described with reference to FIG. 14 and FIG. 15. FIG. 14 and FIG. 15 are views showing an outline of a variable magnification optical system manufacturing method.

In an example shown in FIG. 14, a variable magnification optical system manufacturing method is a manufacturing method of a variable magnification optical system, including: a first lens group having a positive refractive power and arranged closest to an object; a negative lens group having a negative refractive power and arranged closer to an image than the first lens group; and a focusing group arranged between the negative lens group and an aperture stop, the method including the following steps S1 to S3.

That is, as step S1, an arrangement is made when varying magnification such that the distance between the first lens group and the negative lens group is changed, and the distance between the negative lens group and the aperture stop is changed, and an arrangement is made when focusing such that the distance between the focusing group (at least part of the third lens group) and a lens arranged at a position to face an object-side of the focusing group is changed, and the distance between the focusing group (at least part of the third lens group) and a lens arranged at a position to face an image-side of the focusing group is changed. As step S2, the focusing group is constituted by one single lens having a positive refractive power. As step S3, Conditional Expression (1) described below is satisfied.

1.40<f1/ff<2.20 (1)

where

f1: a focal length of the first lens group, and

ff: a focal length of the focusing group.

In an example shown in FIG. 15, a variable magnification optical system manufacturing method is a manufacturing method of a variable magnification optical system, including: in order from an object, a first lens group having a positive refractive power; a second lens group having a negative refractive power; a third lens group having a positive refractive power; and a fourth lens group having a positive refractive power, the method including the following steps S1 to S3.

Step S1: The first to fourth lens groups are prepared, and the third lens group is constituted by one single lens having a positive refractive power. Then, the lens groups are arranged in a lens barrel in order from the object.

Step S2: The variable magnification optical system is made to satisfy Conditional Expression (1) described below.

1.40<f1/ff<2.20 (1)

where

f1: a focal length of the first lens group, and

ff: a focal length of the third focusing group.

Step S3: By providing a known movement mechanism at the lens barrel, the distances between the lens groups are made to be changed when varying magnification from a wide-angle end state to a telephoto end state.

According to the above variable magnification optical system manufacturing method, it is possible to manufacture a variable magnification optical system having a satisfactory optical performance.

### EXPLANATION OF NUMERALS AND CHARACTERS

G1: first lens group

G2: second lens group (negative lens group)

G3: third lens group (focusing group)

G4: fourth lens group (positive lens group)

S: aperture stop

I: image plane

W: wide-angle end state

T: telephoto end state

1. A variable magnification optical system, comprising:
a first lens group having a positive refractive power and arranged closest to an object;
a negative lens group having a negative refractive power and arranged closer to an image than the first lens group; and
a focusing group arranged between the negative lens group and an aperture stop,
wherein when varying magnification, a distance between the first lens group and the negative lens group is changed, and a distance between the negative lens group and the aperture stop is changed,
wherein when focusing, a distance between the focusing group and a lens arranged at a position to face an object-side of the focusing group is changed, and a distance between the focusing group and a lens arranged at a position to face an image-side of the focusing group is changed,
wherein the focusing group is constituted by one single lens having a positive refractive power, and
wherein the following conditional expression is satisfied:
1.40<f1/ff<2.20
where
f1: a focal length of the first lens group, and
ff: a focal length of the focusing group.

2. A variable magnification optical system, comprising:
a first lens group having a positive refractive power and arranged closest to an object;
a negative lens group having a negative refractive power and arranged closer to an image than the first lens group;
a positive lens group having a vibration-reduction group movable such that at least part of the vibration-reduction group has a component in a direction orthogonal to an optical axis; and
a focusing group arranged between the negative lens group and the positive lens group,
wherein when varying magnification, a distance between the first lens group and the negative lens group is changed, and a distance between the negative lens group and the positive lens group is changed,
wherein when focusing, a distance between the focusing group and a lens arranged at a position to face an object-side of the focusing group is changed, and a distance between the focusing group and a lens arranged at a position to face an image-side of the focusing group is changed,
wherein the focusing group is constituted by one single lens having a positive refractive power, and
wherein the following conditional expression is satisfied:
1.40<f1/ff<2.20
where
f1: a focal length of the first lens group, and
ff: a focal length of the focusing group.

3. A variable magnification optical system, comprising:
in order from an object, a first lens group having a positive refractive power; a second lens group having a negative refractive power; a third lens group having a positive refractive power; and a fourth lens group having a positive refractive power,
wherein when varying magnification, a distance between the first lens group and the second lens group is changed, a distance between the second lens group and the third lens group is changed, and a distance between the third lens group and the fourth lens group is changed,
wherein the third lens group is constituted by one single lens having a positive refractive power, and
wherein the following conditional expression is satisfied:
1.40<f1/ff<2.20
where
f1: a focal length of the first lens group, and
ff: a focal length of the third lens group.

4. The variable magnification optical system according to claim 3,
wherein focusing is performed by moving the third lens group along an optical axis.

5. The variable magnification optical system according to claim 1, comprising:
in order from an object, a first lens group having a positive refractive power; and a second lens group having a negative refractive power,
wherein when varying magnification, a distance between the first lens group and the second lens group is changed, and
wherein the following conditional expression is satisfied:
2.00<f1/(−f2)<4.00
where
f1: a focal length of the first lens group, and
f2: a focal length of the second lens group.

6. The variable magnification optical system according to claim 1, comprising:
in order from an object, a first lens group having a positive refractive power; a second lens group having a negative refractive power; and a third lens group having a positive refractive power,
wherein when varying magnification, a distance between the first lens group and the second lens group is changed, and a distance between the second lens group and the third lens group is changed, and
wherein the following conditional expression is satisfied:
1.00<ff/(−f2)<2.30
where
f2: a focal length of the second lens group, and
ff: a focal length of the third lens group.

7. The variable magnification optical system according to claim 1, comprising:
in order from an object, a first lens group having a positive refractive power; a second lens group having a negative refractive power; a third lens group having a positive refractive power; and a fourth lens group having a positive refractive power,
wherein when varying magnification, a distance between the first lens group and the second lens group is changed, a distance between the second lens group and the third lens group is changed, and a distance between the third lens group and the fourth lens group is changed, and
wherein at least part of the fourth lens group moves so as to include a component in a direction orthogonal to an optical axis.

8. The variable magnification optical system according to claim 1, comprising:
in order from an object, a first lens group having a positive refractive power; a second lens group having a negative refractive power; a third lens group having a positive refractive power; and a fourth lens group having a positive refractive power,
wherein when varying magnification, a distance between the first lens group and the second lens group is changed, a distance between the second lens group and the third lens group is changed, and a distance between the third lens group and the fourth lens group is changed, and
wherein the following conditional expression is satisfied:
0.10<ff/f4<0.90
where
ff: a focal length of the third lens group, and
f4: a focal length of the fourth lens group.

9. The variable magnification optical system according to claim 1, comprising:
in order from an object, a first lens group having a positive refractive power; a second lens group having a negative refractive power; and a third lens group having a positive refractive power,
wherein when varying magnification, a distance between the first lens group and the second lens group is changed, and a distance between the second lens group and the third lens group is changed, and
wherein the following conditional expression is satisfied:
60.00<vd3
where
vd3: the Abbe number of the single lens included in the third lens group.

10. An optical apparatus, comprising
a variable magnification optical system according to claim 1.

11. A variable magnification optical system manufacturing method that is a manufacturing method of a variable magnification optical system, comprising:
a first lens group having a positive refractive power and arranged closest to an object;
a negative lens group having a negative refractive power and arranged closer to an image than the first lens group; and
a focusing group arranged between the negative lens group and an aperture stop, the method comprising:
arranging, when varying magnification, such that a distance between the first lens group and the negative lens group is changed, and a distance between the negative lens group and the aperture stop is changed;
arranging, when focusing, such that a distance between the focusing group and a lens arranged at a position to face an object-side of the focusing group is changed, and a distance between the focusing group and a lens arranged at a position to face an image-side of the focusing group is changed; and
configuring such that the focusing group is constituted by one single lens having a positive refractive power,
wherein the following conditional expression is satisfied:
1.40<f1/ff<2.20
where
f1: a focal length of the first lens group, and
ff: a focal length of the focusing group.

12. The variable magnification optical system according to claim 2, comprising:
in order from an object, a first lens group having a positive refractive power; and a second lens group having a negative refractive power,
wherein when varying magnification, a distance between the first lens group and the second lens group is changed, and
wherein the following conditional expression is satisfied:
2.00<f1/(−f2)<4.00
where
f1: a focal length of the first lens group, and
f2: a focal length of the second lens group.

13. The variable magnification optical system according to claim 2, comprising:
in order from an object, a first lens group having a positive refractive power; a second lens group having a negative refractive power; and a third lens group having a positive refractive power,
wherein when varying magnification, a distance between the first lens group and the second lens group is changed, and a distance between the second lens group and the third lens group is changed, and
wherein the following conditional expression is satisfied:
1.00<ff/(−f2)<2.30
where
f2: a focal length of the second lens group, and
ff: a focal length of the third lens group.

14. The variable magnification optical system according to claim 2, comprising:
in order from an object, a first lens group having a positive refractive power; a second lens group having a negative refractive power; a third lens group having a positive refractive power; and a fourth lens group having a positive refractive power,
wherein when varying magnification, a distance between the first lens group and the second lens group is changed, a distance between the second lens group and the third lens group is changed, and a distance between the third lens group and the fourth lens group is changed, and
wherein the following conditional expression is satisfied:
0.10<ff/f4<0.90
where
ff: a focal length of the third lens group, and
f4: a focal length of the fourth lens group.

15. The variable magnification optical system according to claim 2, comprising:
in order from an object, a first lens group having a positive refractive power; a second lens group having a negative refractive power; and a third lens group having a positive refractive power,
wherein when varying magnification, a distance between the first lens group and the second lens group is changed, and a distance between the second lens group and the third lens group is changed, and
wherein the following conditional expression is satisfied:
60.00<vd3
where
vd3: the Abbe number of the single lens included in the third lens group.

16. An optical apparatus, comprising
a variable magnification optical system according to claim 2.

17. A variable magnification optical system manufacturing method that is a manufacturing method of a variable magnification optical system, comprising:
a first lens group having a positive refractive power and arranged closest to an object;
a negative lens group having a negative refractive power and arranged closer to an image than the first lens group;
a positive lens group having a vibration-reduction group movable such that at least part of the vibration-reduction group has a component in a direction orthogonal to an optical axis; and
a focusing group arranged between the negative lens group and the positive lens group, the method comprising:
arranging, when varying magnification, such that a distance between the first lens group and the negative lens group is changed, and a distance between the negative lens group and the positive lens group is changed;
arranging, when focusing, such that a distance between the focusing group and a lens arranged at a position to face an object-side of the focusing group is changed, and a distance between the focusing group and a lens arranged at a position to face an image-side of the focusing group is changed; and
configuring such that the focusing group is constituted by one single lens having a positive refractive power,
wherein the following conditional expression is satisfied:
1.40<f1/ff<2.20
where
f1: a focal length of the first lens group, and
ff: a focal length of the focusing group.

18. The variable magnification optical system according to claim 3, comprising:
in order from an object, a first lens group having a positive refractive power; and a second lens group having a negative refractive power,
wherein when varying magnification, a distance between the first lens group and the second lens group is changed, and
wherein the following conditional expression is satisfied:
2.00<f1/(−f2)<4.00
where
f1: a focal length of the first lens group, and
f2: a focal length of the second lens group.

19. The variable magnification optical system according to claim 3, comprising:
in order from an object, a first lens group having a positive refractive power; a second lens group having a negative refractive power; and a third lens group having a positive refractive power,
wherein when varying magnification, a distance between the first lens group and the second lens group is changed, and a distance between the second lens group and the third lens group is changed, and
wherein the following conditional expression is satisfied:
1.00<ff/(−f2)<2.30
where
f2: a focal length of the second lens group, and
ff: a focal length of the third lens group.

20. The variable magnification optical system according to claim 3, comprising:
in order from an object, a first lens group having a positive refractive power; a second lens group having a negative refractive power; a third lens group having a positive refractive power; and a fourth lens group having a positive refractive power,
wherein when varying magnification, a distance between the first lens group and the second lens group is changed, a distance between the second lens group and the third lens group is changed, and a distance between the third lens group and the fourth lens group is changed, and
wherein the following conditional expression is satisfied:
0.10<ff/f4<0.90
where
ff: a focal length of the third lens group, and
f4: a focal length of the fourth lens group.

21. The variable magnification optical system according to claim 3, comprising:
in order from an object, a first lens group having a positive refractive power; a second lens group having a negative refractive power; and a third lens group having a positive refractive power,
wherein when varying magnification, a distance between the first lens group and the second lens group is changed, and a distance between the second lens group and the third lens group is changed, and
wherein the following conditional expression is satisfied:
60.00<vd3
where
vd3: the Abbe number of the single lens included in the third lens group.

22. An optical apparatus, comprising
a variable magnification optical system according to claim 3.

23. A variable magnification optical system manufacturing method that is a manufacturing method of a variable magnification optical system, comprising:
in order from an object, a first lens group having a positive refractive power; a second lens group having a negative refractive power; a third lens group having a positive refractive power; and a fourth lens group having a positive refractive power, the method comprising:
arranging, when varying magnification, such that a distance between the first lens group and the second lens group is changed, a distance between the second lens group and the third lens group is changed, and a distance between the third lens group and the fourth lens group is changed; and
configuring such that the third lens group is constituted by one single lens having a positive refractive power,
wherein the following conditional expression is satisfied:
1.40<f1/ff<2.20
where
f1: a focal length of the first lens group, and
ff: a focal length of the third lens group.
